(19) United States
(12) Patent Application Publication
(10) Pub. No.: US 2026/0167302 A1
(43) Pub. Date: Jun. 18, 2026

(54) Method for Operating a Pedal-Driven Vehicle and a Pedal-Driven Vehicle

(71) Applicant: Robert Bosch GmbH, Stuttgart (DE)

(72) Inventors: Merlin Martin Manewald, Reutlingen (DE); Daniel Gronbach, Stuttgart (DE); Sebastian Eberle, Tuebingen (DE)

(21) Appl. No.: 19/419,019

(22) Filed: Dec. 14, 2025

(30) Foreign Application Priority Data
Dec. 18, 2024 (DE) 10 2024 212 097.9

(51) Int. Cl. B62M 25/08; B62J 45/412; B62J 45/413; B62K 23/00

(52) U.S. Cl. CPC B62M 25/08; B62J 45/412; B62J 45/413; B62K 23/00

(57) ABSTRACT

A method is disclosed for operating a pedal-driven vehicle that includes a gearshift for providing a variable transmission ratio, a control unit, and a detection unit. The method includes (i) detecting at least one travel parameter, (ii) providing a shift recommendation when at least one travel parameter is outside a predetermined value range, (iii) detecting a rider-generated shift release, and (iv) implementing the shift recommendation in response to the shift release.

This application claims priority under 35 U.S.C. § 119 to patent application no. DE 10 2024 212 097.9, filed on Dec. 18, 2024 in Germany, the disclosure of which is incorporated herein by reference in its entirety.

### BACKGROUND

Pedal-driven vehicles, in particular bicycles or electric bicycles or pedelecs, are typically equipped with a gearshift. The gearshift allows a transmission ratio in a drive train of the vehicle to be adjusted based on the current travel situation. As a result, the propulsion of the pedal-driven vehicle may be made more comfortable for a rider while traveling uphill, downhill, or on flat terrain.

It is generally known that gearshifts can be operated as automatic or semi-automatic gearshifts to automatically trigger or perform shift operations as a function of a specific driving situation. Thus, in an automatic operation of the gearshift, shift operations may be triggered as a function of one or more travel parameters of the pedal-driven vehicle, such as a rider pedaling frequency and/or a speed of the pedal-driven vehicle.

With respect to an automatic operation of the gearshift, it has been shown that automatically triggered shifts with respect to the basic gear selection generally correspond to the rider's request. However, especially in dynamic driving situations, the shift timing selected for the gearshift often does not correspond to the optimal time from the rider's perspective. It has been shown that power transmission in the drive train, in particular in dynamic driving situations (e.g., on off-road trails), can be disrupted by automatically selected shift times for the rider at unfavorable times. This may affect the safety of the rider. Furthermore, shifts operations under comparatively high load are favored, resulting in comparatively high gearshift wear.

### SUMMARY

The present disclosure relates to a method for operating a pedal-driven vehicle, a pedal-driven vehicle, a computer program product, a computer-readable medium, and a data carrier signal.

Further features and details of the disclosure will emerge from the description and the drawings. Features and details described in connection with the method according to the disclosure naturally also apply in connection with the pedal-driven vehicle according to the disclosure and/or in connection with the computer program product according to the disclosure and/or in connection with the computer-readable storage medium according to the disclosure and/or in connection with the data carrier signal according to the disclosure, and vice versa, so that there is or can always be mutual reference with regard to the disclosure of the individual aspects of the disclosure.

The disclosure presented is particularly intended to provide improved operation of an, in particular automatic or semi-automatic, gearshift of a pedal-driven vehicle with respect to improved comfort of use and/or increased safety of the pedal-driven vehicle.

According to a first aspect, the present disclosure relates to a method for operating a pedal-driven vehicle, comprising a gear shift for providing a variable transmission ratio, a control unit, and a detection unit, the method comprising:
detecting at least one travel parameter, in particular by the detection unit,
providing a shift recommendation, in particular by the control unit, if at least one travel parameter is outside a predetermined value range,
detecting a rider-generated shift release, in particular by the control unit and/or the detection unit, and
implementing the shift recommendation in response to the shift release, in particular by the control unit and/or gearshift.

It may preferably be provided that the stated method steps are carried out in the specified order. Additionally or alternatively, it is contemplated that at least individual method steps will be performed recurrently, in particular in a loop and/or, at least in part, simultaneously. Additionally or alternatively, the method can be configured as a computer-implemented method.

In other words, a method for operating a pedal-driven vehicle is proposed. Furthermore, the pedal-driven vehicle includes a gearshift for providing a variable transmission ratio, particularly in a drive train of the pedal-driven vehicle. Furthermore, the pedal-driven vehicle comprises a control unit and a detection unit.

The control unit may preferably be provided to control the sequence of a method according to the first aspect of the present disclosure. The detection unit is preferably configured to detect at least one travel parameter, in particular a rider pedaling frequency and/or a rider torque.

According to the disclosure, it is provided that at least one travel parameter is detected, in particular by the detection unit. Preferably, a travel parameter may be a speed of the pedal-driven vehicle, a rider torque, a rider pedaling frequency, and/or a rider power. In particular, the use of the rider pedaling frequency as the travel parameter has proven to be advantageous in the context of the present disclosure. The rider power may preferably be determined as a product of rider pedaling frequency and rider torque.

It is further provided that, in particular by way of the control unit, a shift recommendation is provided if at least one travel parameter is outside a predetermined value range. For the rider pedaling frequency, this value range may be, for example, a predetermined pedaling frequency range, for the speed a predetermined speed range, for the rider torque a predetermined torque range, and/or for the rider power a predetermined power range. The shift recommendation may be a mere recommendation that a shift operation would or could be advantageous for the rider, in particular without including information on a shift direction or a target gear from the outset. Alternatively, in the course of providing the shift recommendation, a target gear and/or a shift direction may be determined predictively and provided with the shift recommendation. The predetermined value range is thus to be understood as a value range in which the rider can move with the pedal-driven vehicle without his shift recommendation being provided.

According to the disclosure, it is further provided that a rider-generated shift release is detected, in particular by way of the control unit and/or the detection unit. The shift release is intended to be understood as an interaction of the rider with the pedal-driven vehicle, which is characteristic for the rider to agree with the shift recommendation and thus signal their will to perform a shift operation. A shift release may occur through different types of rider interaction that will be discussed below. In particular, the shift release may occur as a rider voice command, a characteristic rider pedaling pattern generated by the rider at the crank mechanism, and/or a user action at a user interface such as a button, switch, touchscreen display, or the like.

Furthermore, it is contemplated that the shift recommendation will be implemented in response to the shift release, in particular by the control unit and/or gearshift. This way that a shift operation corresponding to the shift recommendation is initiated or performed (optionally with additional consideration of the shift release, in particular if this is characteristic for a shift direction). To implement a shift command, the gearshift may preferably be controlled by way of the control unit. In so doing, information on performing the shift operation, such as a target gear or preferably a shift direction, can be transmitted to the gearshift and a corresponding gear change to be performed by the gearshift.

By the method according to the disclosure, control of the time at which shift operations are performed automatically by the gearshift is transmitted to the rider. Thus, the rider-generated shift release is required as an additional criterion so that a planned shift operation based on the shift characteristic of the gearshift is actually implemented, resulting in a semi-automatic operation of the gearshift. In this way, shift operations that are perceived as disruptive by the rider due to their timing of implementation may be avoided, thereby enabling increased rider safety and reduced wear operation of the gearshift.

In particular, the present method or the type of operation of a gearshift depicted herein may be configured as a mode of an automatic gearshift, in particular, which can be activated or deactivated by a user or driver of the pedal-driven vehicle. In particular, the method may comprise activating a semi-automatic mode of the gearshift. Thus, this mode can be activated by a rider, for example on technically challenging passages such as trails or the like, and deactivated in static riding situations, such as when riding cross-country on flat terrain. Enabling or deactivating may occur be via a user interface on the pedal-driven vehicle or via a mobile device. For this purpose, the mobile device can be connected to the pedal-driven vehicle, in particular the gearshift and/or the control unit, via at least one communication interface, for example via a mobile telephone or Bluetooth interface. In particular, activating this mode may cause at least one user interface of the gearshift to be changed in its function for manually triggering gear changes. For example, it can be provided that manual triggering of shift operations is no longer possible via this user interface, but only the generation of a shift release by a user or rider of the pedal-driven vehicle.

Particularly preferably, it can be provided in the context of the present disclosure that detecting comprises at least one travel parameter or consists of a rider pedaling frequency, in particular at a crank mechanism of the pedal-driven vehicle, being detected, preferably by the detection unit. In the present case, the rider pedaling frequency is to be understood as the frequency at which the rider moves the crank mechanism. Thus, the rider pedaling frequency corresponds in particular to the rotation speed of the crank mechanism.

In this context, it can in particular be provided that the provision of the shift recommendation is carried out if the rider pedaling frequency is outside of an, in particular first, target pedaling frequency range. Thus, preferably, a method for operating a pedal-driven vehicle may be provided, the pedal-driven vehicle comprising a gearshift for providing a variable transmission ratio, a crank mechanism for introducing a rider torque to propel the pedal-driven vehicle, a control unit, and a detection unit, the method comprising:
detecting a rider pedaling frequency at the crank mechanism, in particular by the detection unit,
providing a shift recommendation, particularly by way of the control unit, if the rider pedaling frequency is outside of a predetermined value range,
detecting a rider-generated shift release, in particular by way of the control unit and/or the detection unit, and
implementing the shift recommendation in response to the shift release, in particular by the control unit and/or gearshift.

The shift characteristic of the gearshift may be pre-determined as a function of at least one travel parameter, in particular the speed of the pedal-driven vehicle and/or the rider pedaling frequency. The shift characteristic of the gearshift can in particular be represented by at least one target pedaling frequency or a target pedaling frequency range. When the upper limit of the target pedaling frequency range (upper pedaling frequency limit) is reached or exceed, a shift operation to increase the transmission ratio (upshift), and when the lower limit of the target pedaling frequency is reached or undershot (lower pedaling frequency limit), a shift operation may be triggered or recommended to reduce the transmission ratio (upshift). A target pedaling frequency or a target pedaling frequency range may vary for different gears, travel situations, or other influencing variables. In other words, a target pedaling frequency or target pedaling frequency range may be gear-specific and/or drive situation-specific.

A target pedaling frequency should be understood as a driver pedaling frequency that is or can be pedaled by a rider of the pedal-driven vehicle, in particular in a given gear of the gearshift and/or a given travel situation, without an automatic gear change being carried out by the gearshift or a shift recommendation being provided or output. For example, the target pedaling frequency may be a pedaling frequency that is comfortable for a rider, particularly in a specific gear and/or specific driving situation. If, on the other hand, the target pedaling frequency is exceeded by a certain pedaling frequency distance, i.e., if an upper pedaling frequency limit is reached or exceeded, a gear change to a higher gear, i.e. a gear with a higher transmission ratio, can be carried out, in particular automatically, or at least recommended in order to lower the pedaling frequency to the target pedaling frequency or to work toward reducing it. On the other hand, a gear change to a lower gear, i.e. a gear with a lower transmission ratio, can be carried out, in particular automatically, or at least recommended when the pedaling frequency drops below the target pedaling frequency by a certain pedaling frequency distance, i.e., reaches or drops below a lower pedaling frequency limit to increase the pedaling frequency to the target pedaling frequency or to work toward increasing it.

In the present case, an upper pedaling frequency limit is to be understood as a pedaling frequency, upon reaching or exceeding which a shift recommendation in particular to increase a transmission ratio provided by the gearshift, in particular automatically, is provided or a corresponding gear change is performed. Preferably, an upper pedaling frequency limit may be greater than a target pedaling frequency and a lower pedaling frequency limit.

In the present case, a lower pedaling frequency limit is to be understood as a pedaling frequency, upon reaching or undershooting which a shift recommendation, in particular to reduce a transmission ratio provided by the gearshift, in particular automatically, is provided or a corresponding gear change is performed. Preferably, a lower pedaling frequency limit may be less than a target pedaling frequency and an upper pedaling frequency limit.

In particular, the lower pedaling frequency limit constitutes a target pedaling frequency range in conjunction with the upper pedaling frequency limit and with a target pedaling frequency, in particular specific for a given gear and/or a given travel situation, located centrally between the upper and lower pedaling frequency limit. A rider can pedal within this target pedaling frequency range without triggering a shift operation, in particular automatically, or receiving a shift recommendation. If the rider, however, leaves this frequency range with his pedaling frequency, a corresponding shift operation is triggered up or down or at least one shift recommendation is provided. In particular, shift operations are thus triggered or recommended in terms of hysteresis as a function of pedaling frequency limits positioned on both sides of the target pedaling frequency.

The first target pedaling frequency range is preferably limited or formed by a first upper pedaling frequency limit and a first lower pedaling frequency limit. In particular, the first upper and first lower pedaling frequency limits are on either side of a target pedaling frequency. Preferably, the target pedaling frequency may be positioned centrally between the first upper and first lower pedaling frequency limits.

It may preferably be provided in the context of the disclosure that the implementation of the switching recommendation is carried out independently of the shift release if the rider pedaling frequency is outside of a second target pedaling frequency range, in particular wherein the first target pedaling frequency range is within the second target pedaling frequency range. In other words, it may be provided that if the rider pedaling frequency is outside of a second target pedaling frequency range, the shift recommendation is implemented independent of a release by the rider (shift release), i.e. a gear change is carried out. This can effectively avoid particularly unfavorable pedaling frequency ranges for the rider. These may be particularly low and particularly high pedaling frequencies in which a loss of control of the rider is favored or a responsiveness of the rider with respect to maneuvering the pedal-driven vehicle is restricted.

The second target pedaling frequency range is preferably limited or formed by a second upper pedaling frequency limit and a second lower pedaling frequency limit. In particular, the second upper and second lower pedaling frequency limits are on both sides of a target pedaling frequency. Preferably, the target pedaling frequency may be positioned centrally between the second upper and second lower pedaling frequency limits. In particular, the first target pedaling frequency range may be smaller than the second target pedaling frequency range and/or may be included by the second target pedaling frequency range or it may be provided that at least one edge of the second target pedaling frequency range extends across an edge of the first target pedaling frequency range.

It may further be contemplated that detecting the rider-generated shift release comprises at least one of the following:
detecting a rider pedaling pattern characteristic of the shift release at the crank mechanism, in particular by the detection unit, and/or
detecting a user action characteristic of the shift release at at least one user interface of the pedal-driven vehicle.

In other words, it may be provided that detecting the rider-generated shift release comprises detecting a rider pedaling pattern characteristic of the shift release, or consists of detecting such a driver pedaling pattern. For example, the rider pedaling pattern may include a characteristic time curve of the rider torque and/or a rotation angle of the crank mechanism and/or a rider pedaling frequency, in particular within a predetermined time period or time window. In particular, a time curve of the driver torque, in particular at least by way of a torque sensor on the crank mechanism, and/or a time curve of the rotational angle, in particular by way of at least one rotational angle sensor on the crank mechanism, and/or a time curve of the driver pedaling frequency, in particular by way of at least one speed sensor on the crank mechanism, can be recorded for this purpose, preferably by the detection unit.

The stated quantities and/or the respective time curves and/or changes of these variables can be evaluated by the detection unit for the detection of the rider pedaling pattern. Additionally or alternatively, the evaluation can also be carried out by the control unit, for example. For this purpose, the respective values can preferably be transmitted from the detection unit to the control unit.

In particular, for example, a characteristic rider pedaling pattern may be configured such that the rider torque increases, in particular within a predetermined time period, to or above a first torque limit and subsequently drops to or below a second torque limit. The first and/or second torque limit values may be specified as absolute values or relative to a time-averaged value of the rider torque, in particular a moving average. A moving time average is to be understood as a time-averaged rider torque within a fixed (moving) time window linked to a current time.

Such a torque curve differs significantly from an otherwise conventional and substantially sinusoidal curve of the rider torque. In this respect, a shift release can be reliably detected in this way. In particular, such a rider pedaling pattern has also shown to be advantageous for signaling a gear change to a lower gear on the rider's side. In particular, such a rider pedaling pattern may thus be characteristic of a shift direction, wherein in particular the shift direction corresponds to a gear change to a lower gear (lower transmission ratio). In this context, in particular, it can be considered as an additional criterion that the rider pedaling frequency, in particular within the predetermined time period, does not reach or fall below a predetermined pedaling frequency limit. Thus, the pedaling pattern may be characterized by the fact that there is ongoing movement of the crank mechanism by the rider.

Additionally or alternatively, for example, a characteristic rider pedaling pattern can be configured as a pedal break, in particular for a predetermined time period. A pedal break way that the rider pedaling frequency drops to zero or substantially zero, in particular for a limited time period, i.e., in particular the crank mechanism is stationary or substantially stationary, and then increases again, i.e. the movement of the crank mechanism continues. The phrase “substantially” means that, even if the rider is not actively pedaling, environmental movements on the crank mechanism cannot be ruled out due to the movement of the pedal-driven vehicle.

It has proven advantageous with respect to the present disclosure if a pedal break configured as a shift release is limited to a comparatively short time period, i.e. the pedaling frequency already increases or has increased again during this period or upon expiry of this time period. This time period may in particular be 2 seconds, preferably 1 second or less than 1 second. Experience shows that pedal breaks taken by the rider, for example for rest purposes, extend over a relatively long time period and can thus be reliably differentiated from pedal breaks corresponding to a shift release. In particular, such a rider pedaling pattern has also shown to be advantageous for signaling a gear change to a higher gear on the rider's side. In particular, such a rider pedaling pattern may thus be characteristic of a shift direction, wherein in particular the shift direction corresponds to a gear change to a higher gear (higher transmission ratio).

It may be provided that the rider pedaling pattern or the detection of the rider pedaling pattern includes detecting the rider pedaling pattern, in particular the pedal break, at a predetermined rotational angle or within a predetermined turning rotational angle of the crank mechanism. In other words, it may be provided that the rider pedaling pattern is only detected as such when it has been detected in a specific pedal position or range of motion of the pedals over the circumference of the crank mechanism. In this context, the rotational angle can preferably be detected with respect to at least one pedal or at least one crank arm of the crank mechanism. For example, it can be provided that the pedal break is in a horizontal or substantially horizontal pedal position or crank arm position. As a result, such a rider pedaling pattern may be detected even more reliably.

A pedal break characteristic for a shift release can in particular be detected by the rider frequency dropping to a first pedal pedaling frequency limit within a predetermined time period, in particular zero or substantially zero, and then increasing to or above a second pedaling frequency limit. The predetermined time period can in particular be less than or equal to 2 seconds, preferably less than or equal to 1 second. The first and/or second pedaling frequency limit may be absolutely predetermined or may be predetermined relative to a time-based average of the pedaling frequency, in particular a moving average. In particular, the first pedaling frequency limit may be zero or substantially zero, or may be less than the second pedaling frequency limit.

Additionally or alternatively, it may be provided that detecting the rider-side shift release comprises detecting a user action characteristic of the shift release on at least one user interface of the pedal-driven vehicle. This has proven to be a particularly straightforward and reliable way to reliably detect a rider-side shift release. In particular, at least one user interface may be configured as a touch sensitive and/or pressure sensitive control element, in particular a button, switch, sensor, or the like. At least one user interface can also be configured as a touch sensitive display, for example. For example, an existing gearshift user interface may also be used as a user interface for manually triggering gear changes, in particular a shift lever or the like.

In particular, the control unit can be connected to at least one user interface in such a way that user interaction with the user interface transmits a corresponding signal from the user interface to the control unit, thereby enabling the control unit to detect the shift release signal.

Preferably, at least one user interface may be arranged on a handlebar of the pedal-driven vehicle. In particular, the user interface may be arranged on the handlebar such that it is accessible to a rider of the pedal-driven vehicle when the handlebar is used as intended, in particular with a finger.

It may further be provided in relation to the present disclosure that providing the shift recommendation comprises the following:
determining a shift direction, in particular as a function of the rider pedaling frequency and the first target pedaling frequency range, in particular by the control unit, wherein the shift recommendation is characteristic of the determined shift direction.

In other words, it may be provided that, as part of providing the shift recommendation, a shift direction for the recommended shift is determined and provided with or as part of the shift recommendation. A shift direction may be characterized in particular by the fact that a gear change to a higher gear (upshift) or gear change to a lower gear is to be performed.

In particular, the shift direction may be determined as a function of the rider pedaling frequency and the first target pedaling frequency range. In particular, it is possible to determine which edge of the first target pedaling frequency range the rider pedaling frequency is less distant from. If the rider pedaling frequency is less distant from the lower edge (first lower pedaling frequency limit) of the first target pedaling frequency range than from the upper edge (first upper pedaling frequency limit), the shift recommendation may be in particular characteristic of gear changes to a lower gear to raise the rider pedaling frequency again. Whereas, if the rider pedaling frequency is less distant from the upper edge (first upper pedaling frequency limit) of the first target pedaling frequency range than from the lower edge (first lower pedaling frequency limit), the shift recommendation may be in particular characteristic of gear changes to a higher gear to reduce the rider pedaling frequency again.

Additionally or alternatively, the shift direction may be determined as a function of at least one travel parameter, in particular a slope and/or speed and/or acceleration of the pedal-driven vehicle, a rider torque or a rider power, or a change of at least one of these variables. The slope may in particular be detected as a pitch angle of the pedal-driven vehicle such that it can be determined whether the pedal-driven vehicle is moving on a flat surface or on a hill. For example, when driving uphill, it can be concluded that the rider wants a gear change to a lower gear. Furthermore, for example, if acceleration continues and/or the speed increases, it can be assumed that the rider wishes to change to a higher gear. This is also indicated by an increasing or sustained high rider torque or an increasing or sustained high rider power. Preferably, the rider power is calculated as the product of the rider torque and the rider pedaling frequency.

Furthermore, with respect to the disclosure, it may be contemplated that the rider-generated shift release is characteristic of a shift direction. In other words, it is contemplated that the rider specifies the shift direction at the same time as the shift release. In this way, the rider may be given further control over the shift behavior. For example, in a shift release in the form of a pedaling pattern, different pedaling patterns can be provided, wherein one pedaling pattern characterizes an upshift and another pedaling pattern characterizes a downshift. Additionally or alternatively, different user actions may be provided for a shift release at at least one user interface, wherein a first user action characterizes an upshift and a second user action characterizes a downshift. Additionally or alternatively, at least two user interfaces may be provided, wherein a user action on one user interface characterizes an upshift and a user action on the other user interface characterizes a downshift.

Additionally or alternatively, it may be provided that the method further comprises:
outputting a rider indication, particularly by an output unit, in response to providing the shift recommendation.

The rider indication may be configured as an acoustic, visual or haptic cue or any combination thereof. For this purpose, the output unit may comprise, for example, a display element, in particular a display, for outputting a visual rider indication and/or a speaker for outputting an acoustic rider indication and/or at least one vibration actuator for outputting a haptic rider indication. By outputting a rider indication, the shift recommendation may be actively communicated to the rider and the rider may be alerted to generate a shift release. For example, at least one display of the output unit can also be configured as a touch sensitive display and thus also function as a user interface, in particular for a shift release.

Additionally or alternatively, it may be provided within the scope of the disclosure that the method further comprises:
discarding the shift recommendation, particularly by way of the control unit, if the rider pedaling frequency, in particular for a predetermined time period, is within the first target pedaling frequency range.

In other words, it may be provided that when the rider pedaling frequency returns to the first target pedaling frequency range, in particular for a predetermined time period, the shift recommendation is discarded. In particular, in this case, any user action that would correspond to a rider-generated shift release does not trigger a shift operation because there is no shift recommendation for implementation. The same relates to the case of a rider-generated shift release without a shift recommendation having ever been provided. This ensures that a shift operation is only performed if it is deemed to be useful based on the predetermined shift characteristic of the gearshift.

According to a second aspect, the present disclosure relates to a pedal-driven vehicle comprising a gearshift for providing a variable transmission ratio, a control unit, and a detection unit. The pedal-driven vehicle is preferably configured to be operated according to a method according to the disclosure, in particular according to a method according to the first aspect of the disclosure. Preferably, the pedal-driven vehicle may be configured as a bicycle, preferably an electric cycle or pedelec. With respect to a pedal-driven vehicle, the same advantages result as described in relation to a method according to the disclosure. Preferably, the pedal-driven vehicle may comprise two wheels, in particular a front wheel and a rear wheel.

Preferably, the pedal-driven vehicle may comprise a crank mechanism for introducing rider torque to propel the pedal-driven vehicle. In particular, a rider torque and/or a rider pedaling frequency on the crank mechanism can be detected, in particular by a torque sensor or speed sensor. The pedal-driven vehicle preferably comprises a drive for providing a drive torque for propelling the pedal-driven vehicle. The at least one drive may preferably be configured as an electric motor and/or positioned in a center motor assembly on the pedal-driven vehicle. Additionally or alternatively, a plurality of, in particular, similar or identical, drives can be comprised by the pedal-driven vehicle. In particular, the drive may be configured to assist the rider during propulsion of the pedal-driven vehicle.

In particular, the gear shift may be provided to provide a variable transmission ratio, in particular in a drive train of the pedal-driven vehicle. The transmission ratio may be in particular characteristic of the number of revolutions of a drive wheel of the pedal-driven vehicle per revolution of a crank mechanism of the vehicle. In this respect, a high transmission ratio or high gear characterizes a comparatively high number of revolutions of the drive gear per revolution of the crank mechanism. In contrast, a low transmission ratio or low gear characterizes a comparatively low number of revolutions of the drive gear per revolution of the crank mechanism.

Preferably, the pedal-driven vehicle may comprise a crank mechanism. In particular, the crank mechanism allows a rider to apply torque or power to propel the vehicle, via the crank mechanism.

In the present case, the gear shift may be configured as a derailleur gear system or a hub gear. Additionally or alternatively, it may be provided that the gear shift is configured as an automatic or at least partially automated gear shift. In particular, it can be provided that shift operations of the gear shift do not have to be triggered manually by a rider of the vehicle, but instead an initiation and/or performance of shift operation is performed automatically based on one or more travel parameters. A travel parameter may be, for example, a speed of the pedal-driven vehicle, a pedaling frequency of a driver of the pedal-driven vehicle (rider pedaling frequency) and/or a driver torque introduced by a driver of the pedal-driven vehicle to propel the vehicle, or a power provided by a driver of the pedal-driven vehicle to propel the vehicle.

It may be provided that an automatic or at least semi-automatic gearshift comprises at least one user interface, in particular at least one shift lever, for manually triggering a shift operation.

It may be provided in the context of the disclosure that at least one detection unit comprises at least one sensor.

Preferably, the detection unit may comprise at least one slope sensor for detecting a slope of the pedal-driven vehicle. Preferably, at least one slope sensor may be configured as an inertial measurement unit (IMU).

Additionally or alternatively, the detection unit may comprise at least one speed sensor for detecting a speed of the pedal-driven vehicle. For example, at least one speed sensor may be configured to measure a speed of the pedal-driven vehicle, for example, via the rotational speed of a wheel of the pedal-driven vehicle and the outer circumference of the wheel. For this purpose, the speed sensor can be configured as a rotational speed sensor, for example, wherein the speed can be determined via a given outer circumference of the wheel.

Additionally or alternatively, the detection unit may comprise at least one rotational speed sensor for detecting a rider pedaling frequency, in particular at a crank mechanism of the pedal-driven vehicle. Additionally or alternatively, the detection unit may comprise at least one torque sensor for detecting a rider torque, particularly at a crank mechanism of the pedal-driven vehicle. Furthermore, a rider power may be determined as a product of rider pedaling frequency and rider torque. Additionally or alternatively, it may be provided that the detection unit comprises at least one rotational angle sensor for detecting a rotational angle of the crank mechanism. The rotational angle can be detected in particular with respect to at least one crank arm or at least one pedal, in particular arranged on the crank arm. In this way, the circumferential positions of the crank arms or pedals are determined and evaluated.

Preferably, the pedal-driven vehicle, in particular the gearshift, may have at least one user interface. At the user interface, it is preferable to perform a user action characteristic of a shift release generated by the driver (driver-generated). In particular, the user interface may be configured as a touch sensitive and/or pressure sensitive control element, in particular a button, switch, sensor, or the like. At least one user interface can also be configured as a touch sensitive display, for example.

The pedal-driven vehicle may preferably comprise at least one output unit for outputting a rider indication. The output unit may be configured to output a visual and/or audible and/or haptic rider indication.

In particular, the output unit may comprise at least one display element for displaying a visual rider indication. The display element may preferably be configured as a display. Additionally or alternatively, the output unit may comprise at least one output element for outputting an audible rider indication. Preferably, at least one output element may be configured as a speaker. Additionally or alternatively, the output unit may comprise at least one actuator for output or for generating a haptic rider indication. For example, the actuator may be configured as a vibratory motor. At least one actuator can be arranged, for example, on a handle or handlebars of the pedal-driven vehicle. Such positioning has been shown to be particularly advantageous with respect to the transmission of haptic indications.

Additionally or alternatively, it may be provided that the output unit is configured to control a drive of the pedal-driven vehicle to output a haptic rider indication. For example, a drive torque provided by the drive at a crank mechanism of the pedal-driven vehicle may be altered or controlled such that this alteration is noticeable by a rider on the crank mechanism. In particular, the torque may be alternated between two values or increased and lowered again repeatedly. In this way, a haptic indication may be generated for the rider without use of additional actuators.

At least one control unit may be preferably brought into communication and/or signal communication with a gear shift, in particular at least one user interface of the pedal-driven vehicle, and/or the detection unit and/or an output unit, at least temporarily. Thus, data and/or control or regulating signals between the units may be exchanged.

At least one control unit and at least one detection unit may be configured as a common unit.

It may be provided in the context of the disclosure that at least one gearshift and/or control unit and/or detection unit and/or output unit comprises a data processing device. The data processing device may comprise at least one processor and/or working memory and/or non-volatile data store.

According to a third aspect, the present disclosure relates to a computer program product, comprising instructions which cause a pedal-driven vehicle in accordance with the second aspect to execute a method in accordance with the first aspect. With respect to a computer program product according to the disclosure, the same advantages result in that they have already been described in relation to a method according to the disclosure and/or a pedal-driven vehicle according to the disclosure.

According to a fourth aspect, the present disclosure relates to a computer-readable medium, in particular a storage medium, wherein a computer program product according to the third aspect of the disclosure is stored on the computer-readable medium. With respect to a computer-readable medium according to the disclosure, the same advantages result in that they have already been described in relation to a method according to the disclosure and/or a pedal-driven vehicle according to the disclosure and/or a computer program product according to the disclosure.

According to a fifth aspect, the present disclosure relates to a data carrier signal transmitting a computer program product according to the third aspect of the present disclosure. With respect to a data carrier signal according to the disclosure, the same advantages result in that they have already been described in relation to a method according to the disclosure and/or a pedal-driven vehicle according to the disclosure and/or a computer program product according to the disclosure and/or a computer-readable medium according to the disclosure.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination.

The figures schematically show the following:

FIG. 1 is a view of a method,

FIG. 2 is a view of a pedal-driven vehicle,

FIG. 3 is a view of a rider torque curve over time, and

FIG. 4 is a view of a rider pedaling frequency curve over time.

### DETAILED DESCRIPTION

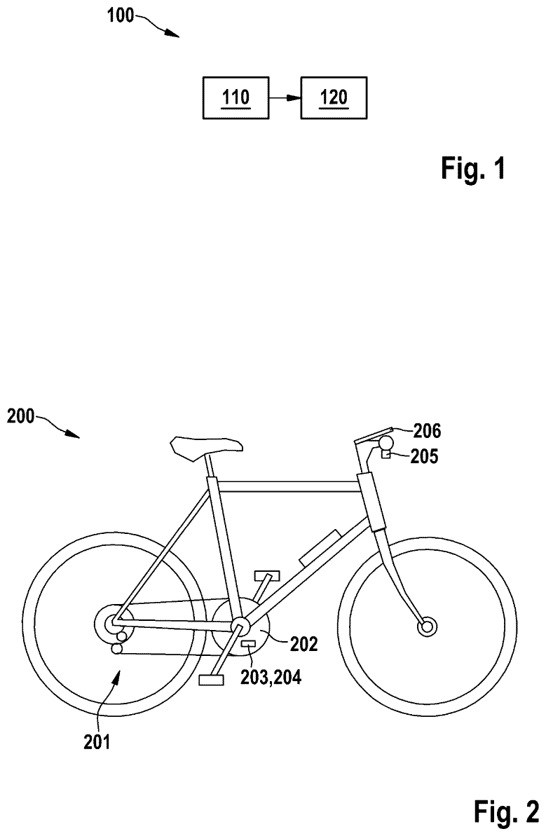

FIG. 1 shows a view of a method 100 for operating a pedal-driven vehicle 200 comprising a gearshift 201 for providing a variable transmission ratio, a control unit 203 and a detection unit 204, the method 100 comprising:
detecting 110 at least one travel parameter, in particular by the detection unit 204,
providing 120 a shift recommendation, in particular by the control unit 203, when at least one travel parameter is outside of a predetermined value range,
detecting 130 a rider-generated shift release, in particular by the control unit 203, and
implementing 140 the shift recommendation in response to the shift release, in particular by the control unit 203 and/or gearshift 201.

FIG. 2 further illustrates a pedal-driven vehicle 200 comprising a gearshift 201 for providing a variable transmission ratio, a control unit 203, and a detection unit 204. Preferably, the pedal-driven vehicle 200 is configured to be operated according to a method 100 according to the first aspect of the present disclosure.

Furthermore, the pedal-driven vehicle 200 includes a crank mechanism 202 for introducing a rider torque FM to propel the pedal-driven vehicle 200.

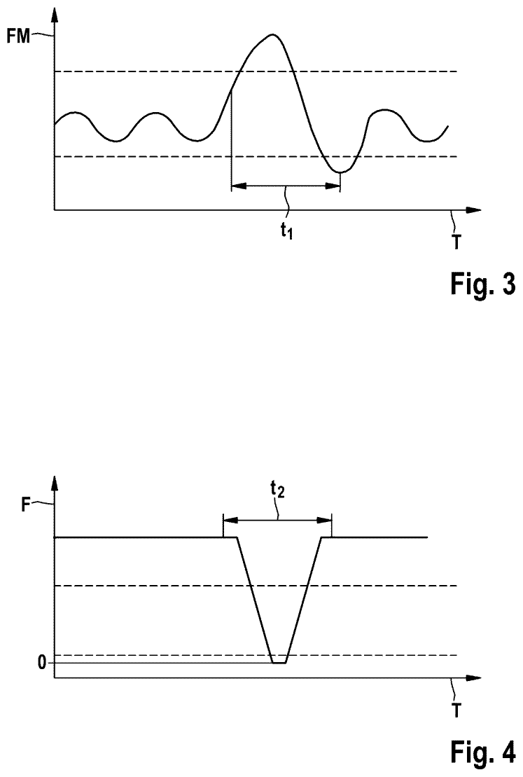

FIG. 3 shows a schematic curve of the rider torque FM over time T. The curve of the rider torque FM includes a rider pedaling pattern characteristic of a shift release. The rider pedaling pattern is characterized by increasing to or above a first torque limit and subsequently dropping to or below a second torque limit within a predetermined time period t1. The torque limits are represented by the dashed lines in FIG. 3. It can be seen from FIG. 3 that this pedaling pattern clearly stands out from a conventional and substantially sinusoidal curve of the rider torque.

FIG. 4 shows a schematic curve of the rider pedaling frequency F over time T. The curve of the rider pedaling frequency F includes a rider pedaling pattern characteristic of a shift release. The rider pedaling pattern is characterized by a pedal break. This is characterized by the rider pedaling frequency F dropping to a first pedaling frequency limit close to zero within a predetermined time period t2 and subsequently rising to or above a second pedaling frequency limit. The pedaling frequency limits are shown in FIG. 3 by the dashed lines. It can be seen from FIG. 4 that this pedaling pattern clearly stands out from a conventional and substantially constant curve of the rider pedaling frequency.

The above explanation of the embodiments describes the present disclosure solely within the scope of examples. Of course, individual features of the embodiments can be freely combined with one another, if technically feasible, without leaving the scope of the present disclosure.

What is claimed is:

1. A method for operating a pedal-driven vehicle that includes a gearshift for providing a variable transmission ratio, a control unit, and a detection unit, the method comprising:
detecting at least one travel parameter by the detection unit;
providing a shift recommendation by the control unit when the at least one travel parameter is outside of a predetermined value range;
detecting a rider-generated shift release by the control unit and/or the detection unit; and
implementing the shift recommendation in response to the shift release by the control unit and/or the gearshift.

2. The method according to claim 1, wherein:
detecting at least one travel parameter comprises detecting a rider pedaling frequency at a crank mechanism of the pedal-driven vehicle, and
providing the shift recommendation occurs when the rider pedaling frequency is outside of a first pedaling frequency range.

3. The method according to claim 2, wherein:
the implementation of the shift recommendation is independent of the shift release when the rider pedaling frequency is outside of a second target pedaling frequency range.

4. The method according to claim 1, wherein detecting the rider-generated shift release comprises at least one of the following:
detecting a rider pedaling pattern characteristic of the shift release at the crank mechanism by the detection unit, and/or
detecting a user action characteristic of the shift release at at least one user interface of the pedal-driven vehicle.

5. The method according to claim 4, wherein:
detecting a rider pedaling pattern characteristic of the shift release comprises detecting the rider pedaling pattern at a predetermined rotational angle or within a predetermined rotational angle range of the crank mechanism.

6. The method according to claim 1, wherein:
providing the shift recommendation comprises determining a shift direction as a function of the rider pedaling frequency and the first target pedaling frequency range by the control unit, and
the shift recommendation is characteristic of the determined shift direction.

7. The method according to claim 1, wherein the rider-generated shift release is characteristic of a shift direction.

8. The method according to claim 1, further comprising:
outputting a rider indication by an output unit in response to providing the shift recommendation.

9. The method according to claim 1, further comprising:
discarding the shift recommendation by way of the control unit, if the rider pedaling frequency for a predetermined time period is within the first target pedaling frequency range.

10. A pedal-driven vehicle, comprising:
a gearshift configured to provide a variable transmission ratio;
a control unit; and
a detection unit,
wherein the pedal-driven vehicle is configured to be operated according to the method of claim 1.

11. A computer program product comprising instructions that cause a pedal-driven vehicle to perform the method according to claim 1.

12. A computer-readable medium on which the computer program product according to claim 11 is stored.

13. A data carrier signal transmitting the computer program product according to claim 11.

14. The method according to claim 3, wherein the first target pedaling frequency range is within the second target pedaling frequency range.
